(19) United States
(12) Patent Application Publication
(10) Pub. No.: US 2010/0325331 A1
(43) Pub. Date: Dec. 23, 2010

(54) CONTROL SYSTEM AND METHOD FOR DATA STORAGE

(75) Inventor: MING-CHIH HSIEH, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/502,238

(22) Filed: Jul. 14, 2009

(30) Foreign Application Priority Data
Jun. 17, 2009 (CN) 200910303334.5

(51) Int. Cl. G06F 13/20; G06F 13/00

(52) U.S. Cl. 710/302; 710/32

(57) ABSTRACT

A control system for data storage includes an electronic device, and a swap device. The electronic device includes a swap device detection module, first and second swap modules, and a storage device detection module. If the swap device is inserted in the electronic device, the swap device detection module outputs a first interrupt signal, the first swap module transfers data to be written to a first storage device to the swap device instead. If the first storage device is removed and a second storage device is inserted in the electronic device, the storage device detection module sends a second interrupt signal, the second swap module transfers data written and to be written to the swap device to the second storage device instead.

### BACKGROUND

1. Technical Field

The present disclosure relates to control systems and methods for data storage, and particularly to a control system with a removable storage device in an electronic device and a control method for data storage utilizing the control system.

2. Description of Related Art

Common digital electronic devices, such as hard disk video recorders, are widely used. A hard disk video recorder is to convert signals, images, videos, sounds, or other information from a device (e.g., a camera) into digital signals to be stored in a hard disk of the hard disk video recorder. The hard disk supports hot plug, which means users can plug new hard disks in the hard disk video recorder and use the new hard disks without restarting the recorder. However, if the hard disk is removed, due to, e.g., the disk being full, from the recorder while data is being stored in the hard disk, the data saving process will be suddenly interrupted, thereby leading to data loss.

### BRIEF DESCRIPTION OF THE DRAWINGS

FIG. 1 is a block diagram of an exemplary embodiment of a control system for data storage, together with a storage device.

FIG. 2 is a flowchart of an exemplary embodiment of a control method for data storage.

### DETAILED DESCRIPTION

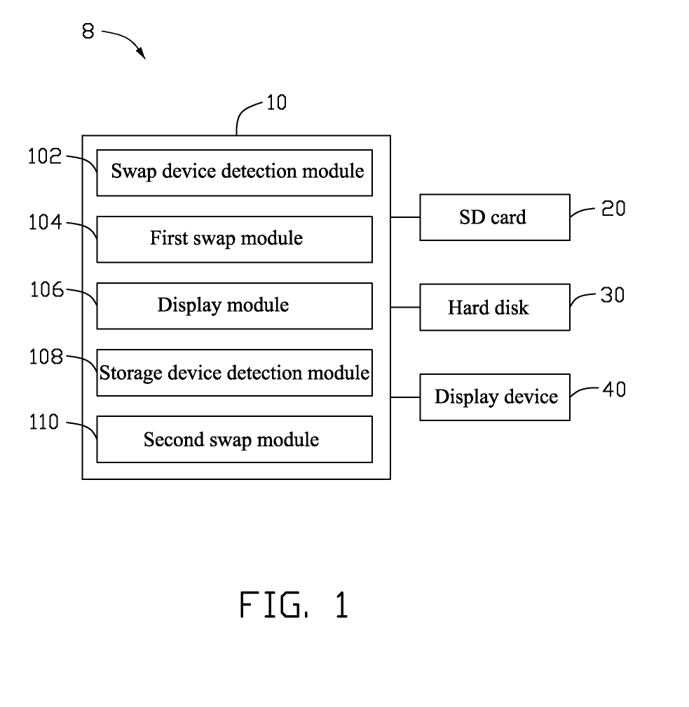

Referring to FIG. 1, an exemplary embodiment of a control system 8, which can prevent data loss, with a removable storage device, such as a hot plug hard disk 30, is shown. The control system 8 includes an electronic device 10, a swap device, such as a secure digital (SD) card 20, and a display device 40. The electronic device 10 is connected to the SD card 20, the display device 40, and the hard disk 30. In one embodiment, the electronic device can be a hard disk video recorder or another kind of electronic device, and the display device 40 can be a plurality of light emitting diodes (LEDs), or a display.

The electronic device 10 includes a swap device detection module 102, first and second swap modules 104, 110, a display module 106, and a storage device detection module 108.

The swap device detection module 102 is to detect whether the SD card 20 is inserted in the electronic device 10. If the SD card 20 is inserted in the electronic device 10, the swap device detection module 102 outputs a first interrupt signal to the first swap module 104.

The first swap module 104 is to transfer data to be written to the hard disk 30 to the SD card 20 instead according to the first interrupt signal, so as to prevent data loss from insufficient space in the hard disk 30, and send an instruction command to the display module 106.

The display module 106 is to receive the instruction command, and control the display device 40 to display instruction information indicating that the hard disk 30 can be removed. The display module 106 is also to receive a control command output from the second swap module 110, and control the display device 40 to display instruction information indicating that the SD card 20 can be removed. In one embodiment, if the display device 40 comprises two LEDs, two of the LEDs lit may indicate that the hard disk 30 can be removed. If the display device 40 is a display, captions, such as “yes” displayed on the display may indicate the hard disk 30 can be removed. In other embodiments, the display module 106 can be omitted according to requirements.

The storage device detection module 108 is to detect whether the hard disk 30 is removed. After the hard disk 30 is removed, the storage device detection module 108 is to detect whether another hard disk or the hard disk 30 is inserted in the electronic device 10. If the another hard disk or the hard disk 30 is inserted in the electronic device 10, the storage device detection module 108 sends a second interrupt signal to the second swap module 110.

The second swap module 110 is to transfer data written and to be written to the SD card 20 to the hard disk just inserted in the electronic device 10 instead according to the second interrupt signal, so as to prevent data loss. After finishing transferring data from the SD card 20 to the hard disk just inserted in the electronic device 10, the second swap module 110 sends a control command to the display module 106 indicating that the SD card 20 can be removed.

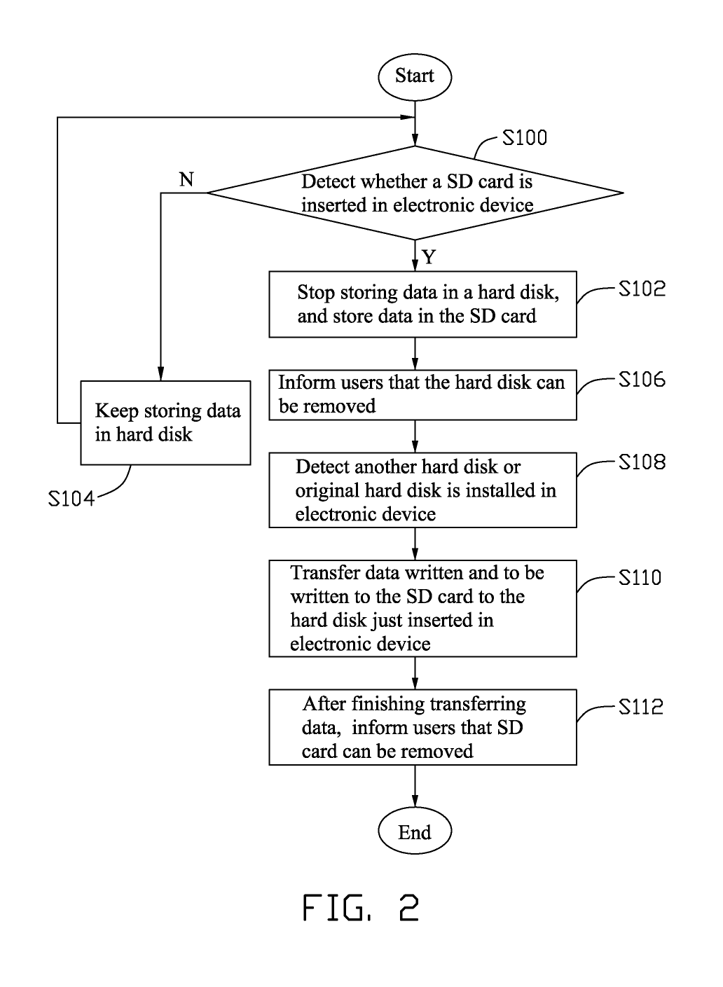

FIG. 2 is an exemplary embodiment of a control method applied in the above mentioned control system 8 with a removable storage device, such as the hard disk 30, to prevent data loss. The control method includes the following steps.

In step S100, the swap device detection module 102 detects whether the SD card 20 is inserted in the electronic device 10. If the SD card 20 is inserted in the electronic device 10, the procedure goes to step S102. If the SD card 20 is not inserted in the electronic device 10, the procedure goes to step S104.

In step S102, the swap device detection module 102 outputs a first interrupt signal to the first swap module 104, the first swap module 104 transfers data to be written to the hard disk 30 be written to the SD card 20 instead according to the first interrupt signal, so as to prevent data loss from insufficient space in the hard disk 30. The procedure goes to step S106.

In step S104, the swap device detection module 102 does not output the first interrupt signal, and data keeps being stored in the hard disk 30. The procedure goes to step S100.

In step S106, the first swap module 104 sends an instruction command to the display module 106, the display module 106 receives the instruction command, and controls the display device 40 to display instruction information indicating that the hard disk 30 can be removed.

In step S108, the hard disk 30 is removed, and the storage device detection module 108 detects the hard disk 30 is removed, the storage device detection module 108 detects whether another hard disk or the hard disk 30 is just inserted in the electronic device 10. If the another hard disk or the hard disk 30 is inserted in the electronic device 10, the storage device detection module 108 sends a second interrupt signal to the second swap module 110.

In step S110, the second swap module 110 transfers data written and to be written to the SD card 20 to the hard disk just inserted in the electronic device 10 instead according to the second interrupt signal, so as to prevent data loss.

In step S112, after finishing transferring data from the SD card 20 to the hard disk just inserted in the electronic device 10, the second swap module 110 sends a control command to the display module 106 indicating that the SD card 20 can be removed.

It is to be understood, however, that even though numerous characteristics and advantages of the embodiments have been set forth in the foregoing description, together with details of the structure and function of the embodiments, the disclosure is illustrative only, and changes may be made in details, especially in matters of shape, size, and arrangement of parts within the principles of the embodiments to the full extent indicated by the broad general meaning of the terms in which the appended claims are expressed.

What is claimed is:

1. A control system for data storage, comprising:
a swap device; and
an electronic device comprising:
a swap device detection module to detect whether the swap device is inserted in the electronic device, and outputs a first interrupt signal in response to the swap device being inserted in the electronic device;
a first swap module to transfer data to be written to a first storage device to the swap device instead according to the first interrupt signal;
a storage device detection module to detect whether the first storage device is removed, and whether a second storage device is inserted in the electronic device, and outputs a second interrupt signal in response to the second storage device being inserted in the electronic device; and
a second swap module to transfer data written and to be written to the swap device to the second storage device instead according to the second interrupt signal.

2. The system of claim 1, further comprising a display device, wherein the electronic device further comprises a display module, the first swap module is to send an instruction command to the display module to control the display device to display instruction information indicating that the first storage device can be removed.

3. The system of claim 2, wherein the second swap module is to send a control command to the display module indicating that the swap device can be removed after finishing transferring data from the swap device to the second storage device.

4. The system of claim 2, wherein the display device comprises a plurality of light emitting diodes.

5. The system of claim 1, wherein the swap device is a secure digital card.

6. The system of claim 1, wherein the first and second storage devices are hard disks supporting hot plug.

7. The system of claim 1, wherein the electronic device is a hard disk video recorder.

8. A control method for data storage, comprising:
detecting whether a swap device is inserted in an electronic device, and storing data in a first storage device connected to the electronic device in response to the swap device being not inserted in the electronic device;
outputting a first interrupt signal to transfer data to be written to the first storage device to the swap device instead in response to the swap device being inserted in the electronic device;
removing the first storage device, and outputting a second interrupt signal in response to a second storage device being inserted in the electronic device; and
transferring data written and to be written to the swap device to the second storage device according to the second interrupt signal.

9. The method of claim 8, further comprising:
sending a control command indicating that the swap device can be removed after finishing transferring data.

10. The method of claim 8, further comprising:
sending an instruction command to control a display device to display instruction information indicating that the first storage device can be removed.

11. The method of claim 8, wherein the electronic device is a hard disk video recorder.

12. The method of claim 8, wherein the swap device is a secure digital card.
